(19) United States
(12) Patent Application Publication
(10) Pub. No.: US 2026/0274429 A1
(43) Pub. Date: Sep. 17, 2026

(54) PROPULSION UNIT FOR AN AIRCRAFT

(71) Applicants: SAFRAN AIRCRAFT ENGINES, Paris (FR); SAFRAN NACELLES, GONFREVILLE-L'ORCHER (FR)

(72) Inventors: Pierre Charles CARUEL, MOISSY-CRAMAYEL (FR); Lionel Jean Léon LEFRANC, MOISSY-CRAMAYEL (FR); Joseph TAGLIALAVORE, MOISSY-CRAMAYEL (FR); Bruno Albert BEUTIN, MOISSY-CRAMAYEL (FR); Valerio CAPASSO, MOISSY-CRAMAYEL (FR); Laurent BLIN, MOISSY-CRAMAYEL (FR); Guillaume GLEMAREC, MOISSY-CRAMAYEL (FR)

(73) Assignees: SAFRAN AIRCRAFT ENGINES, Paris (FR); SAFRAN NACELLES, GONFREVILLE-L'ORCHER (FR)

(21) Appl. No.: 19/131,064

(22) PCT Filed: Nov. 15, 2023
(86) PCT No.: PCT/FR2023/051801

§ 371 Date: May 21, 2026

(30) Foreign Application Priority Data
Nov. 24, 2022 (FR) FR2212291

(51) Int. Cl. B64D 33/08; B64D 27/10; B64D 29/06

(52) U.S. Cl. CPC B64D 33/08; B64D 27/10; B64D 29/06

(57) ABSTRACT

A propulsion unit for an aircraft includes an engine pylon, a turbine engine fixed to the engine pylon, and a cowling. The turbine engine includes a fluidic system, and the cowling has at least one panel that is pivotably connected to the engine pylon and carries at least one surface heat exchanger. The surface heat exchanger includes a fluidic circuit connected to the fluidic system by at least one telescopic link.

### TECHNICAL FIELD OF THE INVENTION

The present invention relates to a propulsion unit for an aircraft.

### TECHNICAL BACKGROUND

The prior art comprises in particular the documents FR-A1-3 094 750, US-A1-2020/318546, US-A1-2020/049028 and DE-A1-10 2006 054003.

FIG. 1 illustrates a propulsion unit 10 for an aircraft.

In this application, “propulsion unit 10” for an aircraft means an assembly comprising a pylon 12, a turbomachine 14 and its cowling 16.

The engine pylon 12 is a solid part used to attach a turbomachine 14 to an aircraft, for example to a wing of the aircraft. The engine pylon 12 therefore comprises elements for attachment to the aircraft and elements for attachment of the turbomachine 14. The engine pylon 12 has a generally elongated shape and extends along a first axis A.

In the present application, the turbomachine 14 is located under the engine pylon 12 or next to the engine pylon. The turbomachine may be suspended from the engine pylon 12 below the wing of the aircraft. Alternatively, the turbomachine may be installed at the rear of the fuselage of the aircraft.

The turbomachine 14 has a generally elongated shape along a second axis B which may be parallel to the first axis A. The first and second axes A, B lie in the same plane P. This plane P may be vertical or inclined to the vertical.

12 o'clock and 6 o'clock are positions of parts around the second axis B, by analogy with the face of a clock when the assembly is viewed from behind. The 12 o'clock position is located in the plane P and at the level of the engine pylon 12, and the 6 o'clock position is located in the plane P under the turbomachine 14.

The turbomachine 14 comprises a lubrication system 18 which, in particular, lubricates the bearings of the turbomachine by circulating lubricating oil.

The cowling 16 surrounds the turbomachine 14 and extends along the second axis B. The cowling 16 may comprise several pieces and comprises two panels 20 of generally semi-circular shape which extend on either side of the aforementioned plane P. These panels 20 comprise upper longitudinal edges 22 which are attached to the engine pylon 12 and arranged on either side of the plane P, close to the 12 o'clock position, and lower longitudinal edges 24 which are generally attached to each other and are therefore located at the 6 o'clock position.

These panels 20 are hinged at their upper edges 22 so that the cowling 16 may be opened to allow access to the turbomachine 14 during a ground maintenance operation, for example. This hinge is made possible by hinges 25 for attaching the upper edges 22 of the panels 20 to the engine pylon 12. Each of the panels 20 is hinged about a third axis C, which may be parallel to the second axis B, for example, from a closed position wherein its lower edge 24 is at the 6 o'clock position, to an open position wherein its lower edge 24 is away from the 6 o'clock position.

The cowling 16 may carry at least one surface heat exchanger 26. An exchanger 26 of this type comprises an oil circuit 26′ connected to the lubrication system 18, and an exchange surface which is exposed to a flow of cooling air. A heat exchange between the surface and the oil circuit 26′ of the exchanger allows to cool the oil coming from the lubrication system 18 before returning it to this lubrication system 18, as illustrated by the dotted arrows in FIG. 1.

At least a part of the cowling 16 may internally define an annular duct for the flow of air around the turbomachine 14, such as a flow duct for a secondary flow or the like. In this case, the exchange surface of the heat exchanger surface 26 is swept by this air flow.

The heat exchanger 26 carried by the cowling 16 is connected to the lubrication system 18 by fluidic connection means which must allow the panels 20 to be opened and in particular pivoted, without necessarily requiring the heat exchanger 26 to be disconnected from the lubrication system 18.

In the current technique, these connection means are flexible hoses 28, as shown in FIG. 2. Each of these hoses 28 comprises one end 28a secured to a panel 20 and configured to be connected to the exchanger 26 carried by this panel 20, and an opposite end 28b secured to the engine pylon 12 and configured to be connected to the lubrication system 18 of the turbomachine 14. Whatever the position of the panel 20, the oil circuit 26′ of the exchanger 26 remains connected to the lubrication system 18 thanks to the flexibility of the hoses 28. FIG. 2 shows two distinct states of deformation of the same hose 28 for two different positions of a panel 20.

This technology has its disadvantages. Firstly, the environment around the hoses 28 must remain free so as not to impede the movement of the hoses 28 when the panels 20 are opened and closed. The hoses 28 are also relatively long so that they may bend without causing stresses that lead to breakage or to a permanent deformation. This technology is therefore relatively bulky. Furthermore, these hoses 28 are oversized to be sufficiently resistant and in particular have a large diameter due to the presence of a thick layer of protection around these hoses 28 in order to resist fire and other aggressions. Finally, this technology is relatively expensive and has a high mass.

The climate change is also a major concern for many legislative and regulatory bodies around the world. Various restrictions on carbon emissions have been, are being or will be adopted by various states. In particular, an ambitious standard applies both to new types of aircrafts and to those already in circulation, requiring the implementation of technological solutions so as to bring them into line with current regulations. For several years now, the civil aviation has been working to help combat climate change. The technological research efforts have already led to significant improvements in the environmental performance of the aircrafts. The Applicant takes into account the impacting factors in all phases of design and development to obtain aeronautical elements and products that consume less energy, are more environmentally friendly and whose integration and use in civil aviation have moderate environmental consequences with the aim of improving the energy efficiency of the aircrafts. Consequently, the Applicant is constantly working to reduce its negative impact on the climate by employing methods and using development and manufacturing methods that are virtuous and minimize greenhouse gas emissions to the minimum possible in order to reduce the environmental footprint of its business. This sustained research and development work is focused on the new generations of aircraft engines, making aircraft lighter, particularly through the materials used and the lighter on-board equipment, developing the use of electrical technologies for propulsion and, as an essential complement to technological progress, the aeronautical biofuels.

The present invention provides a simple, effective and economical solution to at least some of the aforementioned problems of the prior art.

### SUMMARY OF THE INVENTION

The invention is the result of technological research aimed at significantly improving performance of the airplanes and, in this sense, contributes to reducing the environmental impact of the airplanes.

The invention relates to a propulsion unit for an aircraft, this propulsion unit comprising:
a turbomachine extending along a main axis and comprising a fluidic system,
a cowling that extends along and around said main axis, the cowling comprising at least one panel that extends around said main axis, said at least one panel comprising a longitudinal edge that is hinged by hinges that define a pivot axis for the panel, from a closed position wherein it extends around the turbomachine to an open position wherein it is spaced apart from the turbomachine, said at least one panel carrying at least one surface heat exchanger which comprises a fluidic circuit connected to said fluidic system,
   characterized in that the fluidic circuit is connected to the fluidic system by at least one telescopic link which comprises at least one tubular rod movable in translation in a tubular body along an axis of elongation of the link, the telescopic link having a length which varies as a function of the position of the panel about said pivot axis, the tubular rod comprising a first internal passage in fluidic communication with a second internal passage of the tubular body at least when the panel is in the closed position.

The invention thus proposes to connect the fluidic circuit of the exchanger of the panel to the fluidic system of the turbomachine, by means of at least one telescopic link. The first specific specificity of this telescopic link is that its length automatically adapts according to the position of the panel in relation to the turbomachine. The length of the telescopic link may be adjusted by simply sliding the rod or each rod in the body. There is therefore no particular stress on the link when the panel is moved. Another special characteristic of the link is that it ensures the fluidic circulation between the exchanger and the fluidic system when the panel is closed.

The propulsion unit according to the invention may comprise one or more of the following characteristics, taken alone or in combination with each other:
the telescopic link is integrated into a cylinder for connecting the panel to the turbomachine, this cylinder being configured to cause the panel to pivot about said pivot axis;
the telescopic link is connected to at least one pump;
the telescopic link is integrated into a connecting rod for holding the panel in a predetermined position relative to the turbomachine, this connecting rod extending between the panel and the turbomachine;
a seal is mounted at one end of the body and cooperates with the rod as it moves, and/or a seal is mounted at one end of the rod and cooperates with the body as the rod moves in the body;
the fluidic circuit is connected to the fluidic system by two telescopic links, a first of these telescopic links being connected to an inlet of said fluidic circuit, and a second of these telescopic links being connected to a fluidic outlet of said circuit;
the fluidic circuit is connected to the fluidic system by a single telescopic link wherein the first and second internal passages are independent and connected respectively to a fluidic inlet and to a fluidic outlet of said fluidic circuit;
the first and second internal passages are in fluidic communication whatever the position of the panel about said pivot axis;
the first and second internal passages are fluidly isolated from each other when the panel is in its open position;
the telescopic link comprises a mechanical locking device allowing the tubular rod to be locked relative to the tubular body in a position along said axis of elongation; this allows the cowls to be kept open for maintenance purposes;
at least one valve is mounted between the fluidic system and the telescopic link;
the telescopic link comprises a first tubular rod movable in translation in a second tubular rod which is itself movable in translation in the tubular body along the axis of elongation of the link;
the assembly further comprises an engine pylon to which the turbomachine is attached, the turbomachine being located under the engine pylon and the panels being attached to the engine pylon by said hinges;
   the axes of elongation of the engine pylon and the turbomachine extends in the same plane;
said fluidic circuit is an oil circuit or a coolant circuit;
   the cowling surrounds at least a part of the turbomachine;
the cowling comprises two panels of generally semi-circular shape which extend on either side of said main axis;
each of these panels comprises an upper and a lower longitudinal edge;
the upper longitudinal edge of the or each panel is attached by the hinges;
   the other of the panels carries another heat exchanger or another type of fluidic equipment;
   the or each panel has a general semi-circular shape.

### BRIEF DESCRIPTION OF THE FIGURES

Further characteristics and advantages will be apparent from the following description of a non-limiting embodiment of the invention with reference to the appended drawings wherein:

FIG. 1 is a partial schematic perspective view of a propulsion unit for an aircraft,

FIG. 2 is a schematic perspective view of means for fluidic connection of a heat exchanger to a fluidic system, according to the prior art of the invention,

FIG. 3 is a schematic perspective view of a propulsion unit according to one embodiment of the invention,

FIG. 4 is a very schematic view in axial cross-section of telescopic links for fluidic connection of a surface exchanger to a fluidic system;

FIG. 5 is a very schematic axial sectional view of a telescopic link and illustrates a variant of embodiment of the invention, the link being in a retracted position;

FIG. 6 is a schematic half-view in axial cross-section of another telescopic link and illustrates a variant of embodiment of the invention;

FIG. 7 is a very schematic axial sectional view of the telescopic link in FIG. 5, the link being in a deployed position;

FIG. 8 is a very schematic axial sectional view of a telescopic link and illustrates another variant of the invention;

FIG. 9 is a very schematic view of a telescopic link in axial cross-section and illustrates another variant of embodiment of the invention, the link here being in a retracted position;

FIG. 10 is a very schematic axial sectional view of the telescopic link in FIG. 9, the link being in a deployed position;

FIG. 11 is a very schematic axial cross-section of a telescopic link and illustrates another variant of embodiment of the invention, the link being in a retracted position;

FIG. 12 is a very schematic axial sectional view of the telescopic link in FIG. 11, the link being in a deployed position;

FIG. 13 is a very schematic axial cross-section of a telescopic link and illustrates another variant of embodiment of the invention, the link being in a retracted position;

FIG. 14 is a very schematic axial sectional view of the telescopic link in FIG. 13, the link being in a deployed position;

FIG. 15 is a very schematic view of the telescopic links of FIG. 4, also associated with a circuit for supplying pressurized oil to these links so that they may perform an additional function as cylinders, the telescopic links being used here to supply oil to the fluidic circuit of the exchanger, and

FIG. 16 is a similar view to FIG. 15, wherein the telescopic links are used to move the panel to which they are connected.

### DETAILED DESCRIPTION OF THE INVENTION

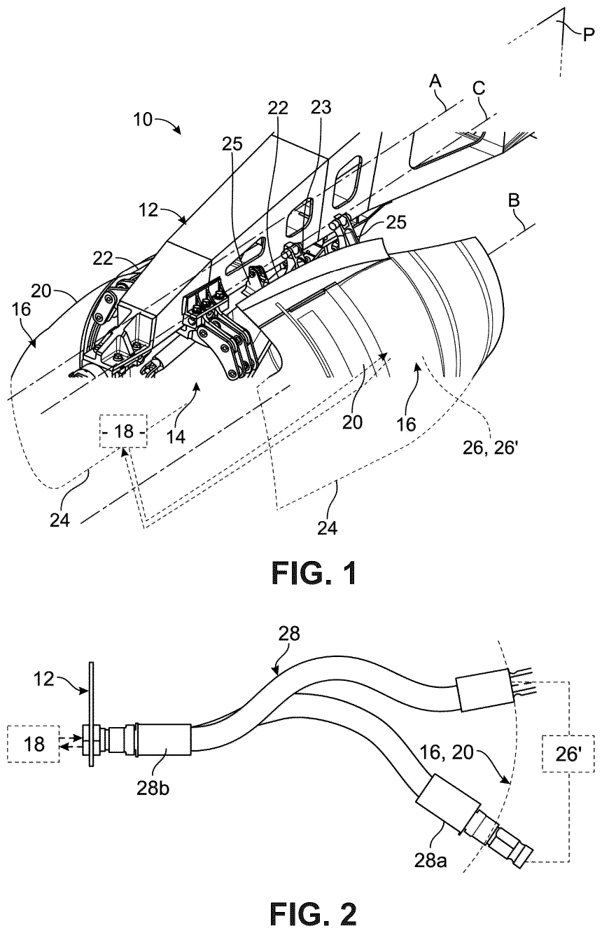

FIGS. 1 and 2 have already been described above.

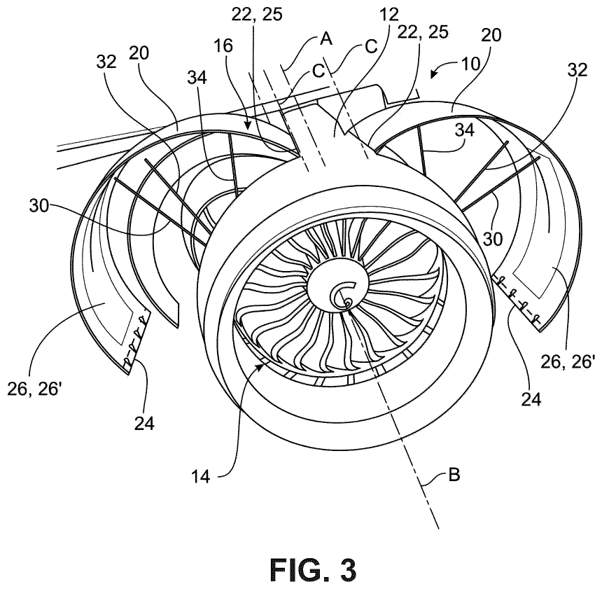

FIG. 3 illustrates an embodiment of a propulsion unit 10 according to the invention. This propulsion unit 10 comprises:
a turbomachine 14 comprising a fluidic system 18, in particular its bearings and rotating elements, and
a cowling 16 which may surround the turbomachine 14, as in the example shown.

The propulsion unit 10 may be located under the wing of the aircraft or at the rear of the fuselage of the aircraft, for example.

The propulsion unit 10 may be of any type, for example a turbojet engine with double or triple flow, a turbomachine with a ducted or non-ducted fan, a turboprop engine, an open rotor, etc.

The propulsion unit 10 may also comprise an engine pylon 12.

The cowling 16 comprises two panels 20 of generally semi-circular shape which extend on either side of a plane P passing through the main axis B of the turbomachine 14 or the respective axes A, B of the engine pylon 12 and the turbomachine 14 when the engine pylon is part of the propulsion unit. The plane P may be vertical or inclined to the vertical.

The panels 20 comprise upper longitudinal edges 22 which are attached by hinges 25. The hinges 25 may be carried by a beam of the turbomachine 14 or by the engine pylon 12 if the latter forms part of the propulsion unit 10.

The upper edges 22 are located substantially in a 12h position, separated from each other by the beam or the engine pylon 12.

The hinges 25 are generally arranged one behind the other along a pivot axis C of the corresponding panel 20.

Each of the panels 20 is hinged about this axis C, which may be parallel to the axis B for example, from a closed position wherein its lower longitudinal edge 24 is substantially at position 6h, to an open position (shown in the drawing) wherein its lower edge 24 is away from the position 6h. The angular deflection (arrow F) between the two positions is, for example, greater than 30° around the axis C.

Each of the panels 20 carries at least one surface heat exchanger 26 which comprises a fluidic or fluid circuit 26′ connected to the fluidic system 18, and an exchange surface which is exposed to a flow of cooling gas.

In the example shown, the exchanger 26 is located on a concave curved surface of the panel 20, which is oriented towards the axis B, and is therefore an internal surface of the panel 20. This position is not exhaustive. Alternatively, the exchanger 26 may, for example, be on an external convex surface of the panel 20.

Indeed, in the context of the present invention, the panel 20 may be an internal or external panel of the turbomachine and of the propulsion unit, and may be swept by a flow of gas passing inside or outside the panel. The exchanger 26 is therefore located inside or outside the panel 20, and therefore positioned on an internal or external surface of this panel 20.

The fluidic system 18 is a lubrication system, for example, but may alternatively be a cooling system. The fluid circuit 26′ is an oil circuit, for example, but may alternatively be a coolant circuit.

The connecting means for fluidic connection of the fluidic circuit 26′ of each exchanger 26 to the fluidic system 18 comprise at least one telescopic link 30.

In the example shown, the fluidic circuit 26′ comprises a fluidic inlet 26a and a fluidic outlet 26b. The fluidic system 18 comprises a fluidic inlet 18a and a fluidic outlet 18b.

The fluidic inlet 26a of the circuit 26′ is connected to the fluidic outlet 18b of the system 18 by a first telescopic link 30, and the fluidic outlet of the circuit 26′ is connected to the fluidic inlet 18a of the system by a second telescopic link 30′.

Each panel 20 may be moved manually. Alternatively, it may be achieved using a hydraulic device comprising at least one cylinder 32 for moving the panel 20 between its end positions.

In this case, the cylinder 32 is connected to a source of fluid such as oil by a pump not shown. The pump supplies oil at a predetermined pressure allowing to extend the cylinder 32 and move the panel 20 about its pivot axis C.

To hold each panel 20 in the open position shown in FIG. 3, the propulsion unit 10 may comprise at least one holding connecting rod 34. A connecting rod 34 of this type extends between the turbomachine 14 and the panel 20, inside the panel, and its length may be fixed so that it holds the panel in an open position.

It is therefore understood that, in the prior art, each panel 20 may be connected to the turbomachine 14 by one or more cylinders 32 and by one or more connecting rods 34.

In the context of the present invention, each telescopic link 30, 30′ also extends between the panel 20 and the turbomachine 14. Each telescopic link 30, 30′ may be independent of the cylinder 32 and of the connecting rod 34. Alternatively, each telescopic link 30, 30′ is integrated into a cylinder 32 or a connecting rod 34.

When a telescopic link 30, 30′ is integrated into a cylinder 32, this cylinder has the dual function of fluidic circulation between the fluidic system 18 and the exchanger 26, and moving the panel 20 between its end positions.

When a telescopic link 30, 30′ is integrated into a connecting rod 34, this connecting rod has the dual function of fluidic circulation between the fluidic system 18 and the exchanger 26, and holding the panel 20 in its open position or in one of its open positions.

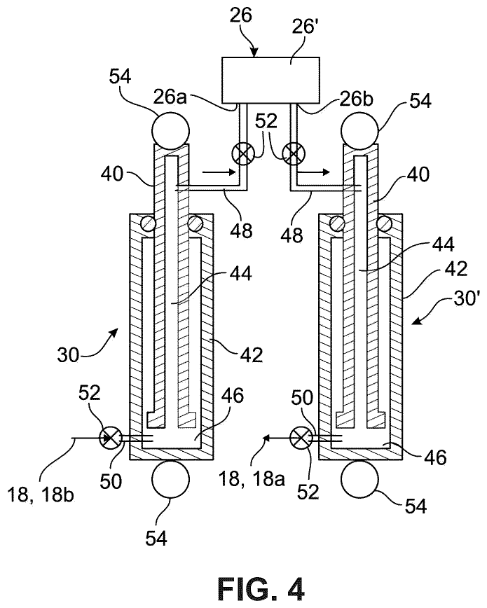

FIG. 4 and following illustrate a number of different embodiments for these telescopic links 30, 30′.

FIG. 4 illustrates a first embodiment wherein the fluidic circuit 26′ of the exchanger 26 is connected by the two aforementioned telescopic links 30, 30′ to the fluidic system 18 of the turbomachine 14.

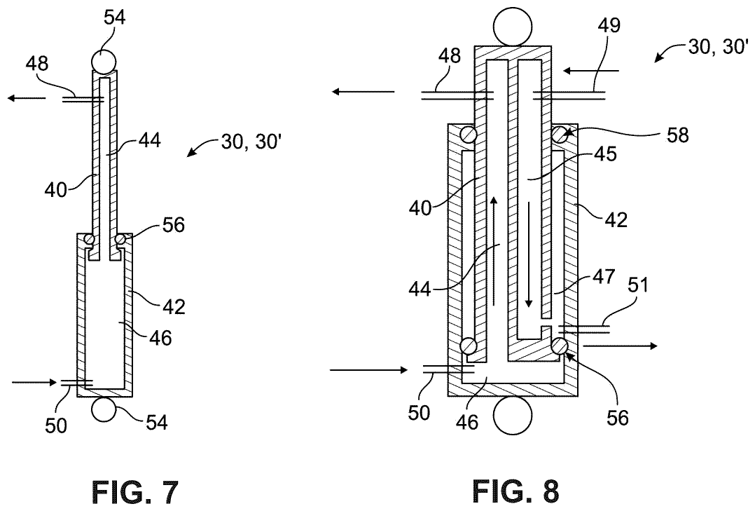

Each telescopic link 30, 30′ comprises a tubular rod 40 which may move in translation in a tubular body 42 along an axis of elongation C of the link. The length of the telescopic link 30, 30′ varies according to the position of the rod 40 in the body 42. When the rod 40 is fully retracted into the body 42, the telescopic link is in the retracted position shown in the drawing. When the rod 40 is fully extended from the body 42, the telescopic link is in a deployed position (see FIG. 7).

The length of each telescopic link 30, 30′ automatically adapts to the position of the panel relative to the turbomachine. The link deploys when the panel opens and the link retracts when the panel closes.

The tubular rod 40 comprises a first internal passage 44 in fluidic communication with a second internal passage 46 of the tubular body 42 at least when the panel is in the closed position and the link is in the retracted position, as shown in the drawing. The passages 44, 46 may also be in fluidic communication when the panel is in the open position and the link is in the deployed position.

In the example shown, the passage 44 in the rod 40 extends inside and along the rod 40 for substantially its entire length. The passage 44 opens out at the end of the rod 40 which is engaged in the body 42 and is in direct fluidic communication with the passage 46 of the body 42, whatever the position of the rod in the body.

The rod 40 comprises a fluidic passage port 48 which is located at the end of the rod located outside the body 42, and which is in fluidic communication with the internal passage 44 of this rod. The body 42 comprises a fluidic passage port 50 which is located at the end of the body 42 opposite that through which the rod 40 exits, and which is in fluidic communication with the internal passage 46 of the body. The port 48 of the link 30 is connected to the inlet 26a of the circuit 26′ and its outlet 26b is connected to the port 48 of the link 30′. The port 50 of the link 30 is connected to the outlet 18b of the system 18 and its inlet 18a is connected to the port 50 of the link 30′. Whatever the position of the rod 40 in the body 42, the ports 48, 50 are always in fluidic communication with the internal passages 44, 46.

It is therefore understood that, whatever the position of the telescopic links 30, 30′ and therefore of the panel 20 relative to the turbomachine 14, the fluidic circuit 26′ of the exchanger 26 is always fluidly connected to the fluidic system 18 of the turbomachine 14.

A valve 52 may be mounted upstream and/or downstream of each telescopic link 30, 30′, to isolate it fluidly from the fluidic system 18 and/or the circuit 26′ as required.

The ends of each telescopic link 30, 30′ may be attached respectively to the panel 20 or to the exchanger 26, and to the turbomachine 14, by swiveling or pivoting links 54.

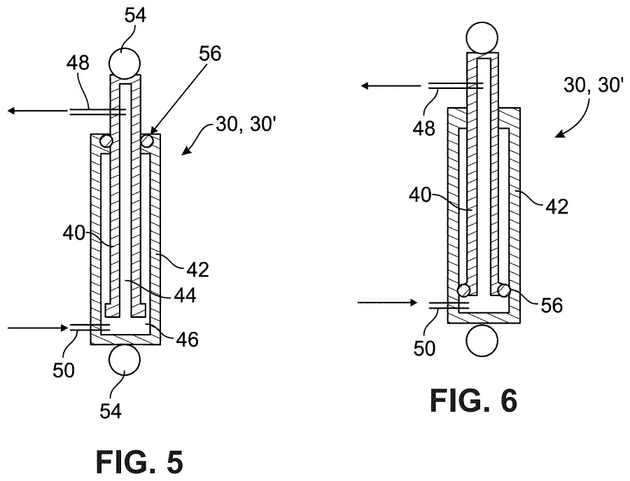

Reference is now made to FIGS. 5 and 6, which illustrate alternative embodiments of a telescopic link 30, 30′ with regard to the sealing means between the body 42 and the rod 40. To prevent a fluidic leakage, the telescopic link 30, 30′ is equipped with at least one seal 56 which may be carried by the body 42 and cooperate with the rod 40, as shown in FIG. 5, or carried by the rod 40 and cooperate with the body 42, as shown in FIG. 6. In FIG. 5, it is the end of the body 42 from which the rod 40 exits that is equipped with the seal 54. In FIG. 6, it is the end of the rod 40 engaged in the body 42 which is equipped with the seal 54.

The configuration shown in FIG. 5 results in pressure equilibrium on both sides, minimizing the pressurization force, which reduces the stresses on the structure when the system is pressurized during operation.

FIG. 8 illustrates a variant embodiment wherein a single telescopic link 30 may be used to fluidly connect the inlet and outlet 26a, 26b of the fluidic circuit 26′ to the fluidic system 18. To achieve this, the telescopic link 30 comprises two independent internal fluidic circuits, as opposed to a single internal circuit in the previous embodiments.

The rod 40 comprises two parallel internal passages 44, 45 which extend along the length of the rod. The internal passage 44 is similar to that described above and opens out at the end of the rod 40 engaged in the body 42. The internal passage 45 opens out on one side of this end. The body 42 comprises two independent internal passages 46, 47. The internal passage 46 is located in the bottom of the body 42 and is in fluidic communication with the passage 44 whatever the position of the rod 40 in the body 42. The internal passage 47 is located on one side or at the periphery of the body 42 and is in fluidic communication with the passage 45 whatever the position of the rod 40 in the body 42.

The rod 40 comprises two fluidic passage ports 48, 49, a first port 48 similar to that described above and which is in fluidic communication with the passage 44, and a second port 49 which is also located at the end of the rod 40 opposite that engaged in the body 42 and which is in fluidic communication with the passage 45.

The body 42 comprises two fluidic passage ports 50, 51, a first port 50 similar to that described above and which is in fluidic communication with the passage 46, and a second port 51 which is located on one side of the body 42 and which is in fluidic communication with the passage 47.

A seal 56 is provided at the end of the rod 40 engaged in the body 42 and allows to isolate the two internal passages 46, 47 from the body. Another seal 58 is provided at the end of the body 42 from which the rod 40 exits, and allows to isolate the internal passage 47 from the outside of the telescopic link 30, 30′.

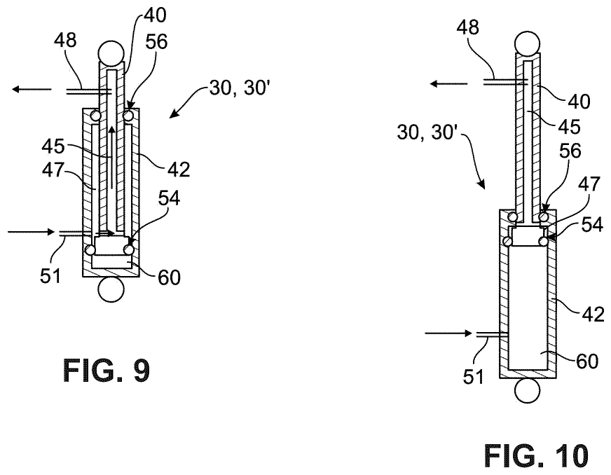

FIGS. 9 and 10 illustrate another embodiment of the invention wherein the internal passages 45, 46 of the rod 40 and of the body 42 communicate with each other when the panel 20 is in the closed position, and do not communicate with each other when the panel 20 is in the open position. It is therefore understood that opening the panel 20 will cause the circuit between the exchanger 26 and the fluidic system 18 to be cut, which limits the risk of leakage, for example.

The rod 40 comprises an internal passage 45 which extends along the rod and opens out on one side of the rod. The body 42 comprises an internal passage 47 which is located to one side or at the periphery of the body and is in fluidic communication with the passage 45 when the rod is in the retracted position shown in FIG. 9. The body 42 also comprises an internal cavity 60 at the bottom of the body, which is isolated from the passage 47 by a seal 54 carried by the end of the rod 40 engaged in the body 42.

In the position shown in FIG. 9, the port 51 is in fluidic communication with the passage 47. In the position shown in FIG. 10, the port 51 is no longer in fluidic communication with the passage 47.

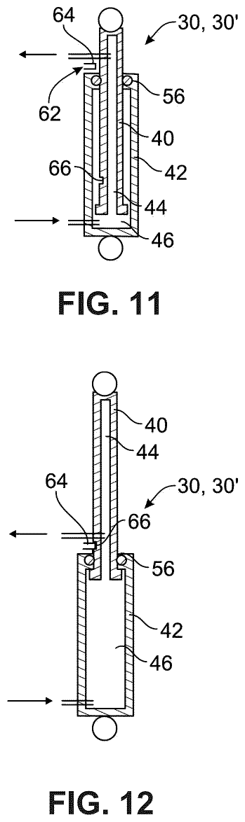

FIGS. 11 and 12 illustrate another alternative embodiment of the invention, corresponding to the case described above, wherein the telescopic link 30, 30′ is integrated into a holding connecting rod 32.

This variant differs from the previous variants essentially in that the telescopic link 30, 30′ also comprises a mechanical locking device 62 for locking the rod 40 in its deployed position or in one of its deployed positions. It is therefore understood that, in addition to the fluidic circulation between the circuit 26′ and the fluidic system 18, the telescopic link 30, 30′ also has the function of being able to hold the link firmly in its deployed position and therefore to hold the panel 20 in its open position.

The device 62 is movable from an unlocked position illustrated in FIG. 11, wherein the rod 40 may slide freely inside the body 42, to a locked position illustrated in FIG. 12, wherein the rod 40 is blocked in the deployed position. Blocking may be achieved, for example, by engaging a finger 64 of the device 62 in an orifice 66 or a slot in the rod 40. The activation of the device 62 may be automatic or controlled.

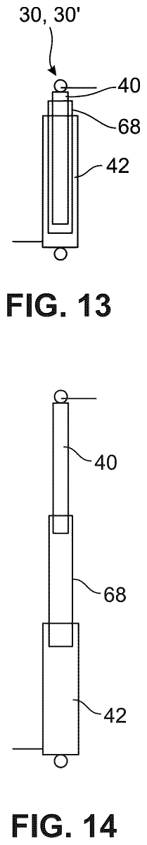

FIGS. 13 and 14 illustrate another alternative embodiment of the invention wherein the telescopic link 30, 30′ comprises more than two elements and in particular two rods 40, 68 and a body 42. A first tubular rod 40 is translationally movable in a second tubular rod 68 which is itself translationally movable in the tubular body 42 along the axis of elongation of the link 30, 30′.

As mentioned above, the internal passages of the rods 40, 68 and of the body 42 communicate with each other when the link 30, 30′ is retracted (FIG. 13) and may also communicate with each other when the link is deployed (FIG. 4).

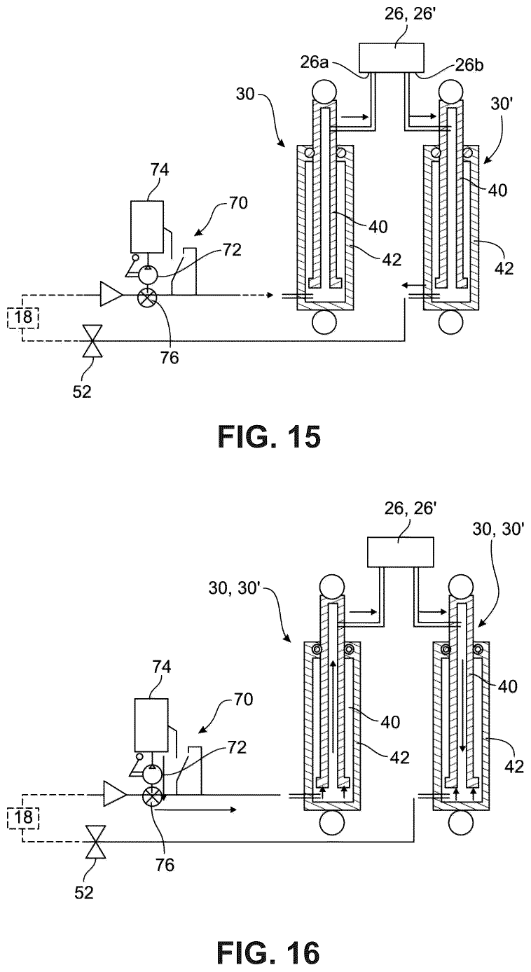

Reference is now made to FIGS. 15 and 16, which illustrate the above-mentioned variant embodiment wherein the telescopic links 30, 30′ also function as cylinders.

As well as being connected to the fluidic system 18, the telescopic links 30, 30′ are connected to a pressurized oil supply circuit 70. This circuit 70 comprises a pump 72 which is connected to a fluidic reservoir 74 which may be a fluidic reservoir of the fluidic system 18. The circuit 70 may be isolated from the telescopic links 30, 30′ by a valve 76.

In FIG. 15, the telescopic links 30, 30′ are used to supply the fluidic circuit 26′ of the exchanger 26 with oil from the fluidic system 18. As the arrows show, the oil from the system 18 passes through the link 30 to join the inlet 26a of the circuit 26′. The oil leaves the circuit via the outlet 26b and then passes through the link 30′ to join the system 18.

In FIG. 16, the telescopic links 30, 30′ both function as cylinders. The valve 52, which connects the telescopic link 30, 30′ to the fluidic system 18, is closed and the circuit 70 is used to supply pressurized oil to both telescopic links 30, 30′. The oil supplied to the telescopic link 30 applies a pressure to the rod 40, forcing it to extend. Some of this oil circulates through the internal passages of the link 30 and into the fluidic circuit 26′ to join the other telescopic link 30′ to also apply a pressure to the rod 40, forcing it to extend. The rods 40 of the two links 30, 30 extend and move the panel 20 from its closed position to its open position. This system is naturally reversible.

The pressure of the oil circulating in the fluidic system 18 and in the circuit 26′ in the case of FIG. 15 is lower than that of the oil in the circuit 26′ in the case of FIG. 16 when the links are used as cylinders. The oil pressure in FIG. 15, for example, is less than or equal to 6 bar. The oil pressure in FIG. 16 is, for example, greater than or equal to 50 bar.

1. A propulsion unit for an aircraft, this propulsion unit comprising:
a turbomachine extending along a main axis and comprising a fluidic system,
a cowling that extends along and around said main axis, the cowling comprising at least one panel that extends around said main axis, said at least one panel comprising a longitudinal edge that is hinged by hinges that define a pivot axis for the at least one panel, from a closed position wherein the at least one panel extends around the turbomachine to an open position wherein the at least one panel is spaced apart from the turbomachine, said at least one panel carrying at least one surface heat exchanger which comprises a fluidic circuit connected to said fluidic system,
wherein the fluidic circuit is connected to the fluidic system by at least one telescopic link which comprises at least one tubular rod movable in translation in a tubular body along an axis of elongation of the at least one telescopic link, the at least one telescopic link having a length which varies as a function of the position of the at least one panel about said pivot axis, the at least one tubular rod comprising a first internal passage in fluidic communication with a second internal passage of the tubular body at least when the at least one panel is in the closed position.

2. The propulsion unit according to claim 1, wherein the at least one telescopic link is integrated into a cylinder to connect the at least one panel to the turbomachine, the cylinder being configured to drive the at least one panel to pivot about said pivot axis.

3. The propulsion unit according to claim 1, wherein the at least one telescopic link is integrated into a connecting rod to hold the at least one panel in a predetermined position relative to the turbomachine, the connecting at least one tubular rod extending between the at least one panel and the turbomachine.

4. The propulsion unit according to claim 1, wherein a seal is mounted at one end of the body and cooperates with the at least one tubular rod as it moves, and/or a seal is mounted at one end of the at least one tubular rod and cooperates with the body as the at least one tubular rod moves in the body.

5. The propulsion unit according to claim 1, wherein the at least one telescopic link is connected to at least one pump.

6. The propulsion unit according to claim 1, wherein at least one telescopic links include first and second telescopic links, the first telescopic link being connected to an inlet of said fluidic circuit, and the second telescopic link being connected to a fluidic outlet of said circuit.

7. The propulsion unit according to claim 1, wherein the fluidic circuit is connected to the fluidic system by a single telescopic link wherein the first and second internal passages are independent and connected respectively to a fluidic inlet and to a fluidic outlet of said fluidic circuit.

8. The propulsion unit according to claim 1, wherein the first and second internal passages are in fluidic communication whatever the position of the at least one panel about said pivot axis.

9. The propulsion unit according to claim 1, wherein the first and second internal passages are fluidly isolated from each other when the at least one panel is in the open position.

10. The propulsion unit according to claim 1, wherein the at least one telescopic link comprises a mechanical locking device configured to block the at least one tubular rod relative to the tubular body in a position along said axis of elongation.

11. The propulsion unit according to claim 1, wherein the at least one telescopic link comprises a first tubular rod movable in translation in a second tubular rod, the second tubular rod being movable in translation in the tubular body along the axis of elongation of the link.

12. The propulsion unit according to claim 1, wherein at least one valve is mounted between the fluidic system and the at least one telescopic link.

13. The propulsion unit according to claim 1, wherein the assembly further comprises an engine pylon to which the turbomachine is attached, the turbomachine being located under the engine pylon and the at least one panel being attached to the engine pylon by said hinges.

14. The propulsion unit according to claim 1, wherein said fluidic circuit is an oil circuit or a coolant circuit.

15. The propulsion unit according to claim 1, wherein the cowling comprises two panels of semi-circular shape which extend on either side of said main axis, each of the two panels comprising an upper longitudinal edge and a lower longitudinal edge, wherein the upper longitudinal edge of each of the two panels is attached by the hinges.
